(19) United States
(12) Patent Application Publication
(10) Pub. No.: US 2026/0229836 A1
(43) Pub. Date: Aug. 6, 2026

(54) PULSED LASER SYSTEM

(71) Applicant: Aqwest LLC, Larkspur, CO (US)

(72) Inventor: David M. Filgas, Newbury Park, CA (US)

(73) Assignee: Aqwest LLC, Larkspur, CO (US)

(21) Appl. No.: 19/530,591

(22) Filed: Feb. 5, 2026

Related U.S. Application Data
(60) Provisional application No. 63/754,541, filed on Feb. 5, 2025.

(51) Int. Cl. H01S 3/23; H01S 3/00; H01S 3/06; H01S 3/1106; H01S 3/16

(52) U.S. Cl. CPC H01S 3/235; H01S 3/0057; H01S 3/0604; H01S 3/1106; H01S 3/1618; H01S 3/1643

(57) ABSTRACT

The present invention provides a pulsed laser system capable of producing pulse trains with pulses of substantially same amplitude. The laser system of the present invention uses a master oscillator (MO), pulse stretcher (which may be based on VBG), binary pulse repetition frequency (PRF) multiplier, a booster amplifier (which may be fiber based), a preamplifier (which may be based on planar waveguide—PWG), a multi-pass amplifier (which may be based on a disk amplifier or a regenerative amplifier), and a pulse compressor. The multi-pass amplifier is the critical part of the subject invention.

### PRIORITY

This patent application claims priority from U.S. provisional patent applications U.S. Ser. No. 63/754,541, filed on Feb. 5, 2025 entitled “Pulse Laser System Generating Multiple Types of Pulses ” the entire contents of all of which are hereby expressly incorporated by reference.

### FIELD OF THE INVENTION

This invention relates generally to pulsed lasers and more specifically to solid-state pulsed lasers generating multiple types of pulse trains, especially bursts of pulses.

### BACKGROUND OF THE INVENTION

There is a strong need for lasers generating high-average power and/or high-pulse energies that are used in industrial, scientific, and defense applications. Exemplary prior art laser devices and systems may be disclosed in Applicant's U.S. Pat. Nos. 7,382,389, 7,955,905, 7,955,906, 8,217,304, 8,809,734, and by others in U.S. Pat. No. 11,495,934, the contents of all of which are incorporated herein by reference. A general block diagram illustrating one type of pulsed laser system of prior art is shown in FIG. 1. This type of laser offers the generation of ultrashort laser pulses which may be used in a wide range of industrial and research applications. In some of these devices, ultrashort pulses are generated in groups (bursts) of 2 or more closely spaced pulses. Such burst may be repeated at a suitable predetermined rate.

One limitation of the aforementioned prior art lasers is that they are susceptible to generating a burst of pulses of decreasing amplitude as shown, for example in FIG. 2. Such a pulse burst, upon amplification in a conventional power amplifier (such as shown in FIG. 1) continue to have uneven or decreasing pulse amplitudes. However, in some important applications it is desirable to produce pulse trains with pulses of substantially the same amplitude.

### SUMMARY OF THE INVENTION

The present invention provides a solid-state pulsed laser system capable of producing bursts of pulses having substantially the same amplitude. The laser system of the present invention uses a master oscillator (MO), pulse stretcher (which may be based on a volume Bragg grating (VBG)), a burst generator configured to create a burst of pulses with an intra-burst repetition rate higher than the PRF of the MO, a booster amplifier (which may be fiber based), a preamplifier (which may be based on planar waveguide (PWG)), a multi-pass amplifier (which may be based on a disk amplifier or a regenerative amplifier), and a pulse compressor.

The multi-pass amplifier is the critical part of the subject invention.

Amplification of pulse trains (especially when formed as bursts of pulses) carries additional challenges and complications compared to amplification of single pulses or continuous trains of pulses, particularly when the length of the burst is short compared to the time required for pumping the amplifier. For example, one may desire to amplify a burst lasting 1-10 nanoseconds (ns) and containing 2-20 pulses using an amplifier in which energy to be extracted is stored during a pump cycle, which may last several hundred microseconds to a few milliseconds. If the amplifier is used in a single-pass mode with high energy extraction, reduction in the stored energy over the duration of the burst leads to a significantly reduced gain for the last pulse in the burst relative to the first pulse in the burst. As a result, there is significant and often undesirable change in the amplified burst waveform compared to the input burst waveform. It is possible to pre-compensate for this distortion by shaping the input waveform using a modulator to yield the desired output waveform, however, such pre-compensation approaches are complex and challenging to optimize.

The subject invention achieves high amplification of bursts of laser pulses while keeping the amplitudes of pulses with the burst at substantially the same level. This assumes that the input pulses within a burst are provided at substantially the same level. The invention uses a power amplifier formed as a multi-pass amplifier, which has a relatively low gain per pass but it provides many passes to attain high gain. Typically, the gain on each pass through the amplifier is less than ~25% per pass and preferably less than 10% per pass. This means that only a small amount of energy is extracted from the amplifier on each pass and there is only a very small change in the amplifier gain for the start of the burst compared to the end of the burst. As a result, the temporal profile of the burst is thus maintained after amplification. Repeating this process a number of times (4 to over 100) is used to eventually boost the pulse amplitude to a targeted level. This process requires that the time between individual passes of bursts through the amplifier is longer than the duration of the burst. While the embodiments described herein focus primarily on solid-state gain media, the same principles of low per-pass energy extraction and multiple-pass amplification may also be applied in other laser systems in which energy is stored in a gain medium and extracted over multiple passes In in some variant of the invention, only one burst at a time may be present in the multipass amplifier. In pulse-pumped amplifiers, the burst may be repeated every pump cycle. In continuously pumped amplifiers, the burst may be repeated once the amplifier gain returns back to a predetermined level.

Multiple passes of the burst through the amplifier can be achieved via polarization multiplexing or via angular multiplexing. Another suitable approach is to use a regenerative amplifier where the burst is switched into the regenerative amplifier cavity, circulates an arbitrary number of times making many passes through the amplifier, and is finally switched out of the regenerative amplifier cavity. These approaches are highly suitable for producing bursts of pulses where the energy in each pulse is essentially equal, i.e., flat-top burst.

Polarization multiplexing is suitable when the total amplification needed can be achieved in only 2 to about 8 passes. Angular multiplexing is suitable when the total amplification can be achieved in 4 to about 24 passes. Regenerative amplification is suitable when the total amplification needed requires 10 to 100 or more passes.

These and other objects of the present invention will become apparent upon reading the following specification and claims.

### BRIEF DESCRIPTION OF THE DRAWINGS

FIG. 1 is a general block diagram illustrating one type of a pulsed laser system of prior art.

FIG. 2 is a view of a typical pulse train generated by a pulsed laser of prior art.

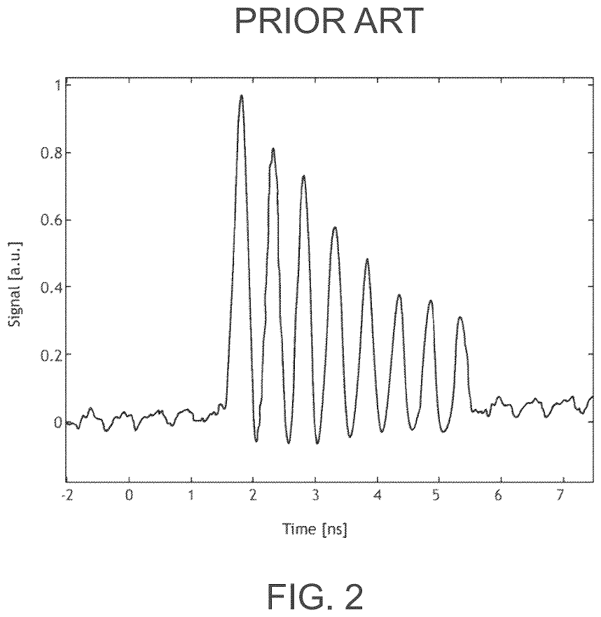

FIG. 3 is a schematic diagram a pulsed laser system in accordance with one preferred embodiment of the subject invention.

FIG. 4 is a view of a typical pulse train generated by a pulsed laser in accrordance with one preferred embodiment of the subject invention.

### DETAILED DESCRIPTION OF THE PREFERRED EMBODIMENTS

Selected embodiments of the present invention will now be explained with reference to drawings. In the drawings, identical components are provided with identical reference symbols in one or more of the figures. It will be apparent to those skilled in the art from this disclosure that the following descriptions of the embodiments of the present invention are merely exemplary in nature and are in no way intended to limit the invention, its application, or uses.

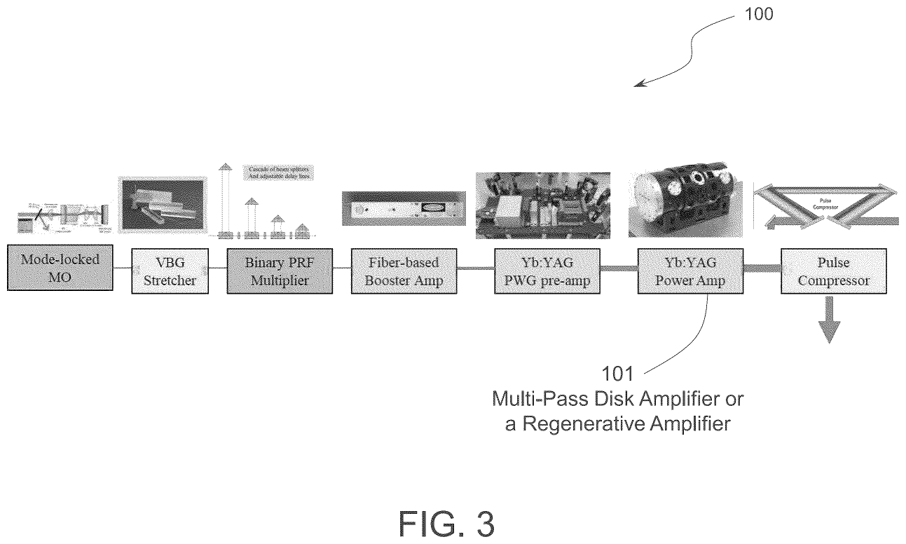

Referring now to FIG. 3, there is shown a pulsed solid-state laser system 100 in accordance with one preferred embodiment of the present invention. The USPL system 100 comprises a master oscillator (MO), pulse stretcher (which may be based on VBG), a burst generator configured to create a burst of pulses with an intra-burst repetition rate higher than the PRF of the MO, a booster amplifier (which may be fiber based), a preamplifier (which may be based on PWG, a multi-pass amplifier 101, and a pulse compressor. The multi-pass amplifier 101 is the critical part of the subject invention and it may be based on a multipass laser disk amplifier or a regenerative amplifier.

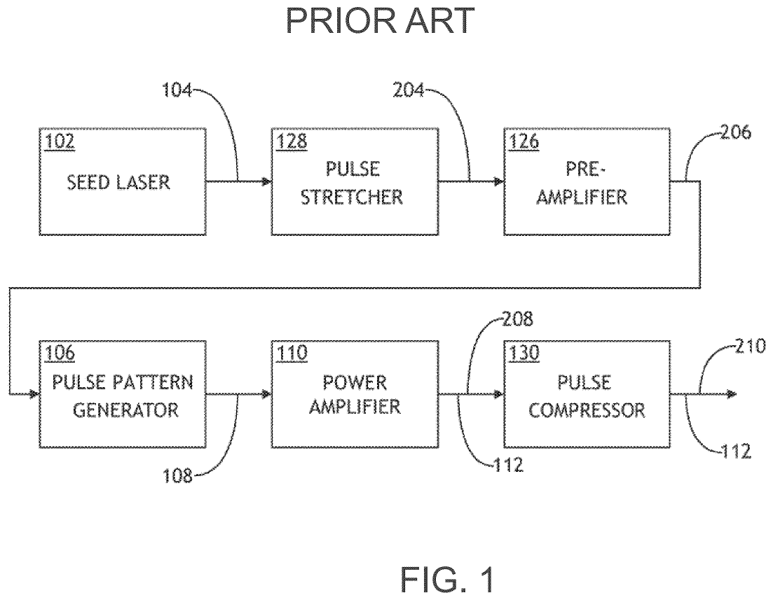

In certain embodiments, the burst generator may be implemented using one or more prisms arranged to direct laser pulses along fixed optical paths such as for example disclosed in Applicant's U.S. Pat. No. 8,809,734. Such prisms may be configured to divide and redirect pulses in a deterministic manner to increase the repetition rate of the pulse train while maintaining substantially uniform temporal spacing between pulses. In these embodiments, the prism positions may be adjusted provide selectable or programmable delay paths for tailoring inter-pulse timing patterns. It will be further understood that the PRF multiplier may alternatively, or additionally, be implemented using other suitable optical elements, including mirrors (such as the pulse patter generator of U.S. Pat. No. 11,495,934 shown in FIG. 1), beam splitters, waveguides, or combinations thereof, provided that such elements are arranged to produce a a desired repetition-rate multiplication.

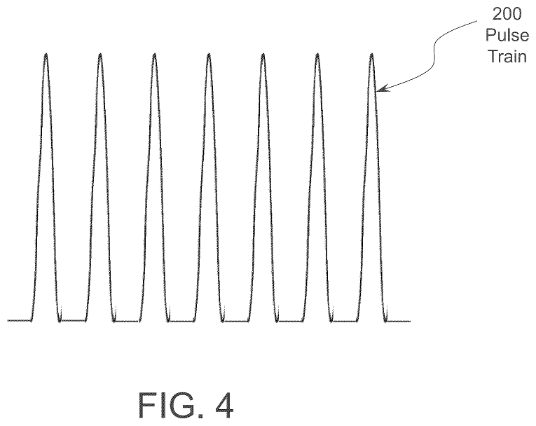

The multi-pass amplifier, is arranged to provide a relatively low energy gain per pass while also arranged to support many passes. With each pass extracting relatively low amount of energy, reapating the process in multiple paseses allows to attain high total energy gain. Typically, the energy gain on each pass through the amplifier is less than ~25% per pass and preferably less than 10% per pass. This means that only a small amount energy is extracted on each pass and there is only a very small change in the amplifier gain for the start of the burst compared to the end of the burst. As a result, the temporal profile of the burst 200 is thus substantially maintained after amplification as shown in FIG. 4. Repeating this process a number of times (4 to over 100) is used to eventually boost the pulse amplitude to targeted level. In particular, the amplifier has a gain element and the amplified beam passes through the gain element between approximately 4 and more than 100 times during amplification of a burst. The burst generator may be implemented using any optical or electro-optical structure capable of producing a predetermined number of pulses with substantially uniform intra-burst spacing, including but not limited to the foregoing examples.

A suitable multipass laser disk amplifier may be angularly switched such as disclosed in U.S. Pat. Nos. 7,463,667 and 9,490,604 the contents of both of which are incorporated herein by reference. For a disk amplifier with gain element(s) configured as “active mirror(s)”, a pass through the amplifier is understood to be a rouind trip (a foreward path toward the reflective surface plus a reverse path reverse path from the reflective surface. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof. In embodiments in which the multi-pass power amplifier is implemented as a regenerative amplifier, a burst of laser pulses is introduced into a regenerative amplification cavity, allowed to circulate through a gain element for a selected number of passes, and then removed from the cavity after amplification. The regenerative amplifier is operated in a manner consistent with the low per-pass gain and multiple-pass amplification regime described herein, such that energy extracted during any individual pass of a burst remains limited and pulse amplitudes within the burst remain substantially uniform after amplification. Appropriate timing and control of the regenerative amplifier are used so that the burst is amplified as a group while maintaining the relative timing of pulses within the burst.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

The term “suitable,” as used herein, means having characteristics that are sufficient to produce a desired result. Suitability for the intended purpose can be determined by one of ordinary skill in the art using only routine experimentation.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

Different aspects of the invention may be combined in any suitable way.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments. For example, while a solid-state pulsed laser system is shown in FIG. 3, the same criteria for the multipass amplifier apply also to gas laser systems. While the embodiments described herein focus primarily on solid-state gain media, the same principles of low per-pass energy extraction and multiple-pass amplification may also be applied in other laser systems in which energy is stored in a gain medium and extracted over multiple passes.

What is claimed is:

1. A pulsed solid-state laser system comprising:
a master oscillator configured to generate laser pulses;
a burst generator configured to create a burst of pulses with an intra-burst repetition rate higher than the PRF of the master oscillator; and
a multi-pass power amplifier configured to amplify bursts of laser pulses;
wherein the multi-pass power amplifier is configured with an energy gain per pass sufficiently low, and a number of passes sufficiently high, such that amplifier gain depletion during each amplification pass of a burst of pulses is suitably low so that pulse amplitudes within the burst remain substantially uniform after amplification.

2. The pulsed laser system of claim 1, wherein the intraburst pulse uniformity after amplification is within 30% of the peak value within the burst.

3. The pulsed laser system of claim 1, wherein the multi-pass power amplifier comprises a multi-pass disk amplifier.

4. The pulsed laser system of claim 1, wherein the multi-pass power amplifier comprises a regenerative amplifier.

5. The pulsed laser system of claim 1, wherein the pulse energy gain per pass of the multi-pass power amplifier is in the range of approximately 5% to 25% per pass.

6. The pulsed laser system of claim 1, wherein the amplifier has a gain element and the amplified beam passes through the gain element between approximately 4 and more than 100 times during amplification of a burst.

7. The pulsed laser system of claim 1, wherein the duration of a pulse burst is short relative to a pump duration of the multi-pass power amplifier, such that energy extracted on any single pass represents only a small fraction of stored energy.

8. The pulsed laser system of claim 1, wherein the duration of the burst is shorter than the time between consecutive amplification passes.

9. The pulsed laser system of claim 1, further including a pulse stretcher and a pulse compressor.

10. The pulsed laser system of claim 1, further including one or more pre-amplification stages.

11. The pulsed laser system of claim 1, wherein the burst generator comprises a binary repetition-rate multiplier configured to generate a uniformly spaced pulse train.

12. The pulsed laser system of claim 11, wherein the burst generator comprises a plurality of prisms arranged to direct laser pulses along predetermined optical paths.

13. A pulsed solid-state laser system comprising:
a master oscillator configured to generate laser pulses;
a pulse stretcher;
a burst generator configured to create a burst of pulses with an intra-burst repetition rate higher than the PRF of the master oscillator; anda multi-pass power amplifier configured to amplify bursts of laser pulses;
a pulse compressor; and
wherein the multi-pass power amplifier is configured with an energy gain per pass sufficiently low, and a number of passes sufficiently high, such that amplifier gain depletion during each amplification pass of a burst of pulses is suitably low so that pulse amplitudes within the burst remain substantially uniform after amplification.

14. The pulsed laser system of claim 13, further including one or more pre-amplification stages.

15. A pulsed laser system comprising:
a master oscillator configured to generate laser pulses;
a burst generator configured to create a burst of pulses with an intra-burst repetition rate higher than the PRF of the master oscillator; and
a multi-pass power amplifier configured to amplify bursts of laser pulses; and
wherein the multi-pass power amplifier is configured with an energy gain per pass of 5-25%, and a number of passes between 4 and 100, such that amplifier gain depletion during each amplification pass of a burst of pulses is suitably low so that pulse amplitudes within the burst remain within 30% of peak value after amplification which is deemed sufficient for material processing, non-linear conversion or ablation applications.
